(19) United States
(12) Patent Application Publication
(10) Pub. No.: US 2006/0099337 A1
(43) Pub. Date: May 11, 2006

(54) Method and device for hardening coils

(76) Inventors: Christian Gruttner, Erwitte (DE); Roland Hoffmann, Briton (DE); Benjamin Weber, Winterberg (DE); Karl Zillmann, Marsberg (DE)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/517,664

(22) PCT Filed: Oct. 29, 2003
(86) PCT No.: PCT/EP03/11966

§ 371 Date: Sep. 15, 2005

(30) Foreign Application Priority Data
Nov. 12, 2002 (DE) 102 52 435.1

(51) Int. Cl. B05D 3/02; B05D 3/10

(52) U.S. Cl. 427/195; 427/487; 427/372.2; 425/429

(57) ABSTRACT

The invention relates to a method for curing coils 16 which have been produced by a winding method, a coil 16 initially being arranged in an oven 12 for curing. The coil 16 is heated up to a predeterminable temperature and rotated about its longitudinal axis 32 to avoid dripping of resin. The conductor or conductors of the coil 16 is or are flowed through by current, in particular by direct current, and heated in this way. The invention also relates an arrangement for curing coils 16, with which the method according to the invention can be carried out.

The invention relates to a method for curing coils which have been produced by a winding method, a coil being arranged in an oven for curing, the coil being heated up to a predeterminable temperature, and the coil being rotated about its longitudinal axis to avoid dripping of resin. The invention also relates to an arrangement for curing coils.

Generally known methods for curing coils provide the following method steps. Firstly, a coil is prepared for the curing process, in that for example a preinsulated conductor is wound around a coil core. In the process, the winding may also take place in a number of layers and, if appropriate, include intermediate layers of insulating material or else a final winding exclusively of insulating material. As soon as the coil has been produced to this extent, it is introduced into an oven for curing.

The insulating materials applied are partly made up by what is known as the insulating resin, or similar substances, which are consequently to be referred to as resin or reaction resin. A reaction resin that is customary today has a number of constituents or basic materials, which are applied to the coil as a resin mixture during the production process. The resin mixture is already more or less viscous. The curing process for the resin, which usually begins by warming up the coil in an oven to reduce the reaction time, initially has the effect of reducing the viscosity of the resin, in other words the resin becomes more runny and consequently the tendency for it to drip from the coil increases. However, the risk of it dripping from the coil already exists in the viscous state of the insulating resin. In order to prevent this, it has previously been customary to rotate the coil continuously about its longitudinal axis with a rotating device already when the coil is being introduced into the oven.

In the case of customary insulating resins, in particular in the case of the reaction resins referred to, this operation continues until its basic materials are chemically crosslinked at an accelerated rate due to increased temperatures and the resin has reached a solidified final state. A disadvantage of this is that the curing operation takes a comparatively long time, for example 24 hours or more. Finally, the oven used for the curing needs a certain time to warm up the entire coil uniformly to the predetermined process temperature. Only after that does the actual curing operation begin.

On the basis of this prior art, it is the object of the invention to provide a method and an arrangement for curing coils in which the process times for curing a coil are shortened.

This object is achieved by the method for curing coils with the features stated in claim 1.

Accordingly, in the case of a method of the type stated at the beginning, it is provided according to the invention that the conductor or conductors of the coil are flowed through by current, in particular by direct current, and is or are heated in this way.

In other words, the coil is now heated in an advantageous way by its own conductor or by its own conductors. That is to say that the coil is heated up particularly quickly to the predeterminable temperature, that is the process temperature of the curing operation, in comparison with the previously customary method. Precisely this time element of the curing operation has previously taken up a particularly great proportion of the time for the overall method, in particular because the warming up of the coil by the oven surrounding it could only be introduced via the surface of the coil and in this way it took a comparatively long time for the temperature profile to reach the process temperature uniformly, in particular in the interior of the coil.

According to the invention, the coil is now warmed up to the process temperature as it were from the inside, by the coil's own current conductor. For this purpose, the conductor is flowed through by current, direct current being suitable in a particularly advantageous way for this operation. In other words, the conductor is as it were used as a heating conductor for warming up the coil and can in this way reach the required temperature profile comparatively quickly. Consequently, the overall time taken by the method for curing coils is also advantageously shortened.

An advantageous refinement of the method according to the invention provides that the coil is rotated forward and back in a predeterminable sequence of rotational movements about its longitudinal axis. It should firstly be stated that the method according to the invention can be readily carried out with the previously customary continuous rotation about the longitudinal axis of the coil. What is required technically for this in the case of an arrangement for curing coils is to be discussed later.

However, it has been found that it is advantageous if the rotational movement of the coil is reversed from time to time. In this way, the device for carrying out the method can be simplified in an advantageous way. A refinement according to the invention of such a device is specified and described in more detail below.

A further advantageous refinement of the subject-matter of the invention provides that, in a rotational movement in a direction about the longitudinal axis up to its reversal point of the next-following change of direction the coil is rotated by an angle unequal to 360° or unequal to an integral multiple thereof. That is to say that, seen spatially, the respective reversal points at the change of direction do not take place at the same location each time, but are slightly offset each time, that is offset by a specific angular amount. In this way, running, or even dripping, of the warmed and consequently runny resin is avoided, in particular at the locations of the reversal points.

The method according to the invention may also be advantageously designed in the way described below. After a specific number of rotations forward and back, for which an angle of rotation other than 360° was chosen, the reversal point progressively shifts in comparison with its original position in accordance with the angle of rotation chosen. For certain reasons, for example on account of the power being supplied by cables, this effect may be undesired. In order to counteract this disadvantage, it is provided according to the invention that a specific number of movements forward and back and the resultant shifting just described of the reversal points are used to change the subsequent reversal points respectively by the angular difference, that is the angle less 360° or an integral multiple thereof, in the opposite direction of shifting. The shifting of the reversal point in the direction now directed counter to the original direction can be continued until the specific number of movements forward and back is in turn reached, that is to say as it were the shifting in the now opposite shifting direction has in turn reached its maximum.

Furthermore, the object is achieved by an arrangement for curing coils with the features stated in claim 8.

In this respect, the invention relates to an arrangement for curing coils which have been produced by the winding method, with an oven, with a rotating device for receiving and rotating a coil arranged in the rotating device, with a heating device for heating the coil and with a control device. According to the invention, it is provided that the conductor or conductors of the coil is or are flowed through by current and at least a contribution to the heating of the coil takes place in this way.

That is to say that the conductor or conductors of the coil is or are used as a heating element by the flow of current through it or them. In this way, the coil is as it were heated from the inside outwards, as a difference from the previous heating by the oven itself from the outside via the surface of the coil. The idea of the invention also includes the previous practice that the oven is heatable, supporting the curing process. It is also advantageous in the case of the arrangement according to the invention that the conductor of the coil is surrounded by that insulating material which is provided for the curing. That is to say that everywhere where the conductor is located, and consequently where there is a region in which the warming up by the conductor takes place, there is also arranged insulating material for the curing. In this way, a uniform process temperature required for the curing process can be achieved in a comparatively short time.

This warming-up phase, as it is known, also requires a comparatively long time in comparison with the overall time taken for the curing. By shortening this phase in particular, that is the warming-up period, the overall duration of the curing operation is advantageously shortened.

In an advantageous development of the subject-matter of the invention, it is provided that the rotating device has a slip ring, by means of which current can be transferred from the heating device to the coil. With the warming up of the coil, in particular of the conductor and of the associated insulation, the insulating resin is also warmed up and consequently softened, as part of the insulation.

In order to avoid the risk of insulating resin dripping, it is provided that the coil is rotated in its rotating device. The slip ring that is provided according to the invention ensures that the coil or the conductor of the coil can be supplied with the required current even during the rotational movement of the rotating device.

An alternative to the slip ring that is provided according to the invention is that the coil is connected to the heating device by means of cables. That is to say that the arrangement for curing coils is simplified. This is so because it is possible to dispense entirely with a comparatively more expensive and technically complex slip ring.

An advantageous refinement of the arrangement according to the invention in which the coil is connected to the heating device by means of cable provides that the coil can be rotated forward and back about its longitudinal axis with the rotating device.

In this respect it is advantageous that the restriction that exists in principle due to the connection of the coil to the heating device by means of cable is avoided by the coil being rotatable forward and back about its longitudinal axis. In this case, the rotation forward and back of the coil can be used up to the maximum length of the cable which connects the coil to the heating device. In this way it is made possible to prevent dripping of insulating resin in spite of the restrictions imposed by the cable on the rotatability of the coil.

A controller is provided for controlling the rotational movements of the coil. Here it may be advantageous if the reversal points from rotation in one direction into the other or back again are based on a previously defined pattern or on a sequence of rotational movements. However, the idea of the invention also includes the concept that the controller is provided for making the switching over of the rotational movement from a movement forward into a movement back or vice versa take place by means of limit monitors, for example a limit switch. Moreover, it is also advantageous if the controller is contained in the control device. It is then possible to dispense as it were with the controller as a separate component and the arrangement according to the invention is advantageously simplified.

Further advantageous refinements of the idea of the invention can be taken from the dependent claims.

The invention, its advantages and further improvements of the invention are to be explained and described in more detail on the basis of the exemplary embodiments specified in the drawings, in which:

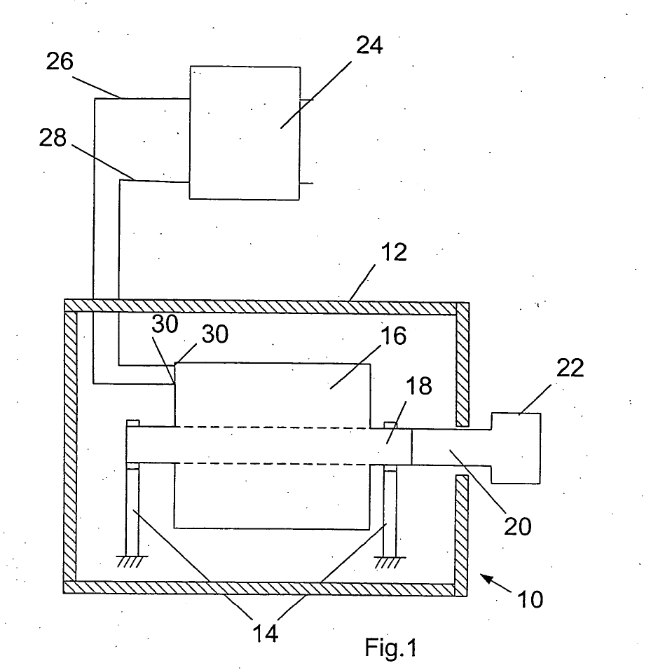

FIG. 1 shows an example of an arrangement for curing coils,

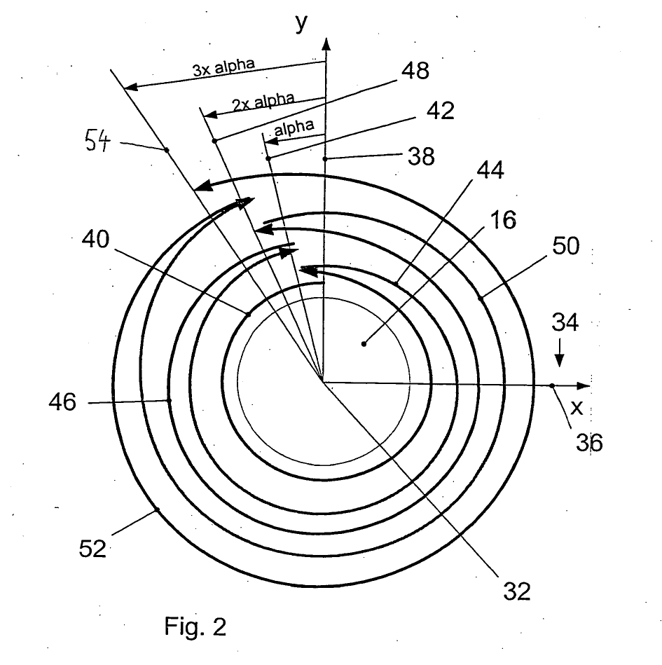

FIG. 2 shows a first diagram of a sequence of movements forward and back and

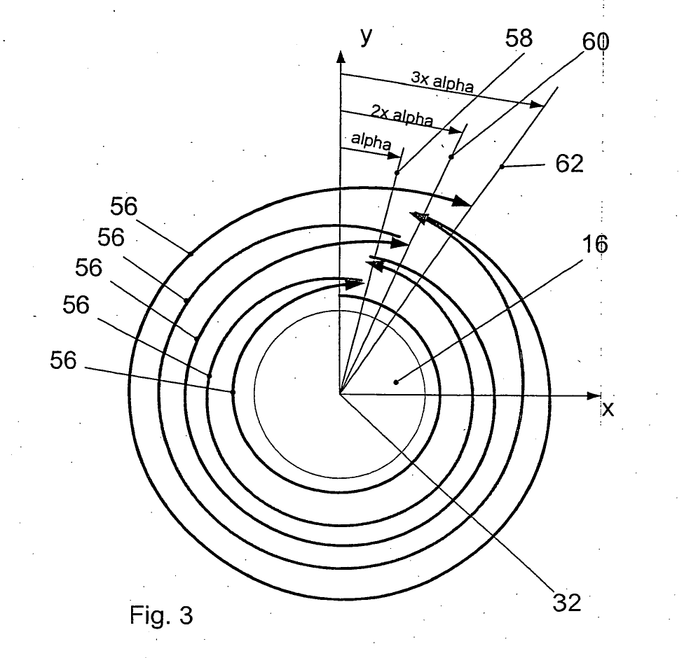

FIG. 3 shows a second diagram of a sequence of movements forward and back.

FIG. 1 shows an example of a first arrangement 10 according to the invention with an oven 12, in which a rack 14 is arranged and which serves for receiving coils which are to be cured. A first coil 16 is arranged in the rack 14 and mounted freely rotatably there. A shaft end 18 of the coil 16 is connected to a drive shaft 20 of a rotating device 22. In the example chosen, the drive (not represented in any more detail) of the rotating device 22 is arranged outside the oven 12 and only engages the drive shaft 20 at one location of a wall of the oven 12, through the latter.

Also shown is a control device 24, which is likewise arranged outside the oven and is connected by means of a first connecting cable 26 and a second connecting cable 28 to two terminals 30 on the first coil 16 with the conductor winding (not represented in any more detail) of the first coil 16.

In the example chosen, the oven 12 has no separate device for heating the oven. In addition, the controller, which is provided for controlling the rotating device, that is the rotational movements of the drive shaft 20, is also to be integrated in the rotating device 22, so is not represented as a separate component in this figure. However, it is quite conceivable, and included in the idea of the invention, that the controller of the rotating device 22 is designed in such a way that it also takes over the functions of the control device 24, or conversely that the control device 24 is designed in such a way that it can also activate the rotating device 22.

In the example, the method for curing according to the invention proceeds as follows. Firstly, the first coil 16 for curing is introduced into the oven 12. The shaft end 18 is connected to the drive shaft 20 and the first connecting cable 26 and the second connecting cable 28 are respectively connected to one of the terminals 30. With the start of the curing operation, the control device 24 switches the current through to the connecting cables 26, 28, with the result that the conductor of the coil is flowed through by current and is warmed up in this way. In a first phase of the curing operation, the entire coil is warmed up comparatively quickly to a predeterminable curing temperature by the heating-up operation in the conductor. The conductor is usually wound helically around a coil core. This arrangement enhances the warming-up process, in particular helps to make the warming-up process more uniform.

From the point in time at which the softening temperature of an insulating resin around the conductor is reached, the rotating device 22 begins to rotate the first coil 16 about its longitudinal axis. The rotating operation may, however, also be started already at an earlier point in time; in particular whenever the insulating resin mixture to be cured is relatively runny, the rotating operation is possibly already started when the insulating resin mixture is applied. In this case, the assembly sequence stated at the beginning has to be correspondingly adapted.

In the example chosen, the conductor of the first coil 16 is connected by the connecting cables 26, 28 directly to the control device 24, without a slip ring interposed. In this case, the rotating device is set such that the rotational movement does not just take place in one direction about the longitudinal axis, but instead it rotates the first coil 16 forward and back about its longitudinal axis. This rotation forward and back is to be explained in more detail in FIGS. 2 and 3.

FIG. 2 shows the first coil 16 in a plan view of its longitudinal axis 32. For purposes of illustration, a system of Cartesian coordinates 34 with an X axis 36 and with a Y axis 38 is shown, the origin of the system of coordinates 34 coinciding in this view with the longitudinal axis, which in this view is in turn only represented as a point.

The starting position of the first coil 16, which may be defined for example by the position of the terminals 30, is intended in the example chosen to lie on the Y axis. The first movement of the first coil 16 is to be performed anticlockwise and is shown by the first path of movement 40. The first path of movement 40 describes an angle, in this example of about 370°; that is to say that, after completing a full circle, the terminals 30 slightly overshoot as it were their original position, as far as a first reversal point 42, which is turned clockwise, that is in the positive direction of rotation, from the starting position by the angle alpha, here 100. On reaching the first reversal point 42, the rotating device 22 switches the direction of rotation over from a rotation forward into a rotation back in the clockwise direction and then the first coil 16 moves in the opposite direction of rotation. This is illustrated by the representation of the second path of movement 44. The movement back continues until the location of the first reversal point 42 is reached again. That is to say that the second path of movement 44 describes a full circle, that is 360°. Then the direction of the rotational movement is in turn reversed, with the consequent result that a movement corresponding to a third path of movement 46 is shown, in turn describing 370° from the first reversal point 42, until it reaches a second reversal point 48 which is correspondingly represented as turned by an angle of twice alpha, that is 20° here, from the Y axis. After a further reversal of the direction of rotation, a fourth path of movement 50 shows a movement corresponding to the second path of movement 44 with regard to the angle described, that is in turn a full circle, until the second reversal point 48 is in turn reached. Finally, the first coil 16 reaches a third reversal point 54, in that it is rotated anticlockwise in turn by 370° in a way corresponding to a fifth path of movement 52. The third reversal point 54 is accordingly turned by 30° with respect to the Y axis.

In the example chosen, the third reversal point 54 is intended to represent the maximum permissible turning of the reversal points, that is here by a maximum of 30° with respect to the Y axis. Once this point is reached, it is provided according to the invention that the rotation which began in the anticlockwise direction in this case is then to take place in the opposite direction, in other words the shifting of the reversal points takes place in a clockwise direction. This is described in more detail in the next figure.

FIG. 3 therefore shows the shifting of reversal points in the clockwise direction on the basis of an example in which the starting point of the first coil 16 is in turn the neutral position, for example the terminals 30 on the X axis. However, it is quite conceivable that the shifting described below in the clockwise direction may also start from the third reversal point 54.

In the example according to FIG. 3, as also in FIG. 2 described above, five paths of movement 56 are shown, the movement performed first by the coil, represented here by the radially innermost path of movement 56, taking place in the clockwise direction of rotation and covering an angle of 370°, until a fourth reversal point 58 is reached. After a corresponding movement of the first coil 16 forward and back, a fifth reversal point 60 is correspondingly reached and, after a further movement forward and back, a sixth reversal point 62 is reached. In accordance with the example chosen, the sixth reversal point 62 is therefore offset by 30° in the clockwise direction of rotation with respect to the Y axis.

If the paths of movement by the first coil 16 that are described above, both of FIG. 2 and of FIG. 3, were performed one after the other, the end position after the completed movement of the terminals 30 would in turn come to lie on the Y axis. After that, the procedure could then continue with a movement corresponding to FIG. 2 or optionally with a movement corresponding to FIG. 3. This achieves the effect that, when each is regarded spatially, the reversal points do not coincide with the same coil position, and accordingly the possibly runny insulating resin, in particular on the underside of the first coil 16, does not find a reversal point at the same location each time due to gravity, and accordingly also does not tend to form drips at a single reversal location.

The following examples, without reference to the figures represented, show the advantageous nature of the invention.

The rotation of the coil about its longitudinal axis by almost any angle to the left and the same angle to the right, with the angle being in particular unequal to 360° or a multiple thereof, for any number of cycles, that is a number of cycles greater than 1, leads to at least two differently situated reversal points. This is a first improvement, which avoids dripping of the insulating resin.

A further improvement is achieved if a different angle is used for the rotation to the left than for the rotation to the right. Both angles can in principle be chosen at will. If rotation is performed, for example, initially 362° to the left and then 357° to the right, the result after one movement forward and back, that is one cycle, is a differential angle of 5°, and consequently the original reversal point is reached again after 72 cycles of this kind. Subsequently, but optionally also after fewer cycles, the reversal of the process could follow, that is initially 357° to the left and subsequently 362° to the right, in order to obtain a cycle.

It goes without saying that the rotating process could also begin with the direction of rotation “to the right”.

A further advantage, in particular with respect to the connecting of fixed cable connections, is obtained if a smaller angle is chosen for the rotation forward than for the rotation back. Taking the example of movement forward of 350° and movement back of 360° for 36 cycles, followed by reversing this for 36 cycles, it is found that the coil moves absolutely between −360° and +360°.

If 360° is chosen for the movement forward and 350° for the movement back for the same cycles, the coil moves absolutely between 0° and +720°.

Therefore, the first variant is advantageous in the case of fixed cable connections, but the second variant is also quite feasible.

### LIST OF DESIGNATIONS

10 first arrangement
12 oven
14 rack
16 first coil
18 shaft end
20 drive shaft
22 rotating device
24 control device
26 first connecting cable
28 second connecting cable
30 terminals
32 longitudinal axis
34 system of coordinates
36 X axis
38 Y axis
40 first path of movement
42 first reversal point
44 second path of movement
46 third path of movement
48 second reversal point
50 fourth path of movement
52 fifth path of movement
54 third reversal point
56 paths of movement
58 fourth reversal point
60 fifth reversal point
62 sixth reversal point

1. Method for curing coils which have been produced by a winding method, a coil being arranged in an over for curing, the coil being heated up to a predeterminable temperature, and the coil being rotated about its longitudinal axis to avoid dripping of resin, wherein the conductor or conductors of the coil is or are flowed through by current, in particular by direct current, and is or are heated in this way.

2. Method according to claim 1, wherein the coil is rotated forward and back in a predeterminable sequence of rotational movements about its longitudinal axis.

3. Method according to claim 1 wherein the predeterminable temperature is changed by a control device in accordance with a previously chosen temperature profile.

4. Method according to claim 1.,wherein, in a rotational movement in a direction about the longitudinal axis up to its reversal point of the next-following change of direction, the coil is rotated by an angle unequal to 360° or unequal to an integral multiple thereof.

5. Method according to claim 4, wherein, after the next change of direction has taken place, the coil is rotated by an angular amount of 360° or an integral multiple thereof in an opposite direction as far as the then-following further reversal point.

6. Method according to claim 5, wherein, after a predetermined number of rotations forward and back, the angle is changed once by twice the angular difference, that is to say the angle less 360° or an integral multiple thereof, with the result that the subsequent reversal point lies on the opposite side of a 360° location by an angular difference.

7. Method according to claim 1, wherein, after reaching a specific terminating criterion, in particular after a specific time, on account of a specific degree of hardness of the insulation or on account of the reaching of a specific characteristic value of a substance, the movement forward and back is ended.

8. Arrangement for curing coils which have been produced by the winding method, with an over for receiving the coil, with a rotating device for receiving and rotating a coil arranged in the rotating device, with a heating device for heating the coil and with a control device for controlling the heating operations and possibly the rotating operations, wherein the conductor or conductors of the coil is or are connected to the heating device, and in that the conductor or conductors are flowed through by current for heating the coil.

9. Arrangement according to claim 8, wherein the rotating device has a slip ring, by means of which current can be transferred from the heating device to the coil.

10. Arrangement according to claim 8, wherein the coil is connected to the heating device by means of cables.

11. Arrangement according to claim 8, wherein the coil can be rotated forward and back about the longitudinal axis with the rotating device.

12. Arrangement according to claim 8, wherein a controller, by means of which the rotational movements of the coil in particular can be controlled, is provided.

13. Arrangement according to claim 12, wherein the controller is contained in the control device.
